(19) United States
(12) Patent Application Publication
(10) Pub. No.: US 2012/0086683 A1
(43) Pub. Date: Apr. 12, 2012

(54) TRANSMISSIVE LIQUID-CRYSTAL DISPLAY IN CMOS TECHNOLOGY WITH AUXILIARY STORAGE CAPACITOR

(75) Inventor: Josep SEGURA PUCHADES, FONTAINE (FR)

(73) Assignee: COMMISSARIAT A L'ENERGIE ATOMIQUE ET AUX ENERGIES ALTERNATIVES, Paris (FR)

(21) Appl. No.: 13/268,182

(22) Filed: Oct. 7, 2011

(30) Foreign Application Priority Data
Oct. 8, 2010 (FR) 1003996

(51) Int. Cl. G09G 5/00; G09G 3/36

(52) U.S. Cl. 345/205; 345/87

(57) ABSTRACT

Techniques for displaying images with an active-matrix liquid-crystal display. These techniques are particularly applicable to small displays, produced, for example, on silicon substrates (in LCOS, or liquid-crystal on silicon, technology). An auxiliary storage capacitor is formed on the drive transistor of a pixel, such that the drive transistor is formed between the liquid crystal and the storage capacitor. The capacitor includes multiple parallel partial capacitors each having an interdigitated structure in a respective metallization level. The metallizations (aluminum and/or copper) are opaque and the capacitor therefore protects the transistor from light, the level of protection being increased with the number of metallization levels used to form the interdigitated structures.

### CROSS-REFERENCE TO RELATED APPLICATIONS

This application claims priority to foreign French patent application No. FR 10 03996, filed on Oct. 8, 2010, the disclosure of which is incorporated by reference in its entirety.

### FIELD OF THE DISCLOSED SUBJECT MATTER

The invention relates to the display of images by an active-matrix liquid-crystal display. It is more particularly applicable to small transmissive displays, produced for example on single-crystal silicon substrates (in LCOS, or liquid-crystal on silicon, technology).

### BACKGROUND

An active-matrix display comprises a matrix of rows and column of pixels, each pixel comprising a liquid crystal between a pixel electrode and a counter electrode common to all the pixels. The voltage applied across the pixel electrode and the common electrode produces an electric field that orients the molecules of the liquid crystal depending on the magnitude of the field. This orientation affects the polarization of the light that passes through the crystal so as to define, in combination with the use of polarizers, a light-transmission level that depends on the electric field applied. A drive transistor (the active element of the pixel) connects the pixel electrode of all the pixels of a given column to a respective column conductor. The column conductor receives at a given moment an analog voltage defining a grayscale to be applied to the pixel. If the transistor is on, this voltage is applied to the pixel electrode; if not, the pixel behaves as an isolated capacitor and keeps the voltage level received previously. The drive transistors of a given row of pixels are controlled by a respective row conductor; thus, when an image line is written, the various rows of the matrix are addressed in succession so as to write, at a given instant, into the pixels in the row addressed, the information applied at this instant by the column conductors.

FIG. 1 shows the general structure of such a matrix, where CL denotes a liquid-crystal cell and Q denotes the transistor associated with this cell, the cell and the transistor together forming the pixel. The common counter electrode is denoted by CE, the electrode of the pixel is denoted by Ep. The row control conductors are denoted by L₁ to Lₙ for a matrix of n rows. The column conductors are C₁ to Cₘ for a matrix of m columns. A row decoder DEC addresses the various rows in succession. A digital/analog conversion circuit DAC applies a set of analog voltages to the column conductors, when a row is addressed, which voltages represent the image to be displayed by this row. The conversion circuit generates these analog voltages based on a digital signal. A sequencing circuit SEQ ensures the synchronous operation of the row decoder and the conversion circuit DAC.

Other circuit elements may be present, such as a circuit for periodically reversing the polarity of the counter electrode. They are not shown.

The liquid crystal between two electrodes behaves as a capacitor. It is this capacitive behavior that makes it possible for the terminals to keep the voltage given to them while the corresponding row is being written. But this capacitor has a low capacitance and it is in general desirable to supplement it with an auxiliary storage capacitor. This is because the leakage current of the drive transistor leads to the loss of charge stored in the capacitor of the pixel, thereby causing a variation in the voltage between the electrodes of the liquid crystal. Moreover, the capacitance of the liquid crystal also varies progressively as the liquid crystal adopts the molecular orientation given to it depending on the applied voltage.

This auxiliary storage capacitor is in principle connected in parallel with the electrodes of the liquid crystal since it acts to increase the specific capacitance of the liquid crystal.

However, as the capacitances in question are relatively low, it has been observed that the gate-source capacitance of the drive transistor Q is not negligible and causes an undesirable modification of the voltage across the terminals of the liquid crystal when application of the write voltage is interrupted. This is because the write voltage is applied via a control pulse to the gate of the transistors Q of a given row. This pulse transfers the desired write voltage to the source of the transistor, causing the capacitor of the liquid crystal and the auxiliary storage capacitor to charge up to this value. However, when the voltage pulse applied to the gate terminates, these two capacitors partially discharge into the gate-source capacitance of the transistor, in proportion to the value of this capacitance. The voltage that then remains on the liquid crystal is not exactly that desired.

To obviate this effect, it is possible to envision the following solutions:
connecting the auxiliary storage capacitor not between the electrode Ep of the liquid crystal and the counter electrode CE, but between the electrode Ep and the control conductor of the following row. FIG. 2 shows the corresponding circuit diagram, in which is shown, for each pixel, a transistor Q, the capacitor C_{cl} of the liquid crystal of this pixel, and the auxiliary storage capacitor Cₛₜ, the latter being connected between the electrode of the pixel (itself connected to the source of the corresponding transistor Q) and the control conductor of the following row Lᵢ₊₁. The voltage loss across the terminals of the liquid crystal when the pulse that switches on the drive transistor ends (falling edge) is compensated for by a corresponding voltage increase at the start (rising edge) of the pulse that switches on the transistors of the following row. This compensation is effective if the capacitance of the auxiliary storage capacitor is equal to the gate-source capacitance of the drive transistor; and
connecting the auxiliary storage capacitor, or an additional compensation capacitor, to an auxiliary row conductor common to all the pixels in the row and delivering an opposite-polarity compensation pulse, of adjustable amplitude, synchronously to the write control pulse. Thus, while the falling edge of the write control pulse tends to reduce the voltage on the pixel electrode, the rising edge of the compensation pulse tends to increase this voltage in proportion to the amplitude of the compensation pulse. By adjusting the amplitude level of the compensation pulse it is possible to compensate for the influence of the end of the write control pulse. FIG. 3 shows that each pixel is then controlled by two row conductors, respectively Lᵢ and L′ᵢ for the row of rank i. The second conductor of row L′ᵢ is connected to the second terminal of the storage capacitor Cₛₜ, the first terminal being connected to the pixel electrode of the liquid crystal and to the source of the transistor Q. All the pixels of the row are connected in this way to the conductor L′ᵢ. Alternatively it is possible to provide both an auxiliary storage capacitor Cₛₜ simply in parallel with the liquid crystal and a compensation capacitor C_{comp}, the compensation capacitor then being connected between the pixel electrode and the row conductor L′ᵢ. These two solutions are shown in FIG. 3.

In any case, at least one capacitor (auxiliary storage capacitor and/or compensation capacitor) is required by the pixel.

In active-matrix display technologies on sheets of glass, in which the transistors are made of amorphous silicon, the pixel is most commonly produced with a configuration such as that shown in FIG. 4. The pixel is rectangular or square and occupies an area between two successive row conductors Lᵢ and Lᵢ₊₁ and two successive column conductors Cⱼ and Cⱼ₊₁. The transparent pixel electrode Ep occupies most of this rectangle, and a corner of the rectangle is occupied by the amorphous-silicon transistor Q the gate of which is connected to the row conductor Lᵢ, the source of which is connected to the electrode Ep, and the drain of which is connected to the column conductor Cⱼ.

The auxiliary storage capacitor Cₛₜ is in this case quite simply formed by a lateral extension of the pixel electrode Ep and by the following row conductor Lᵢ₊₁ which passes over this extension and which is separated therefrom by an insulating layer. This is the configuration shown in FIG. 2 but tailored to amorphous silicon technology. The pixel electrode is made of indium tin oxide (ITO), which has the property of being transparent.

This type of pixel structure can be used in transmissive displays comprising a matrix of transistors made of amorphous silicon.

Small displays produced in LCOS technology, i.e. on a single-crystal silicon substrate, are in general of the reflective type, so that the electrode Ep of the pixel is not transparent but reflective. This electrode is not placed laterally to the side of the drive transistor Q, as it is for amorphous-silicon displays such as that shown in FIG. 4, but completely covers the transistor. The transistor is naturally protected from the light by the electrode of the pixel.

If it is desired to produce a transmissive display in LCOS technology it is no longer possible for the electrode of the pixel to be made of a reflective metal, because it would prevent the passage of light: in a transmissive display the light produced by a light source passes once through the liquid crystal and the layers of electronic circuitry that control the pixels before being observed, or projected onto a screen, whereas in a reflective display the light passes through the liquid crystal once before being reflected by a reflecting electrode and passing once more through the liquid crystal.

In a transmissive display it is therefore necessary for the pixel electrode to be transparent (made of ITO). But then the transistor is exposed to the light and there is a risk that large leakage currents will be induced, these currents varying as a function of the illumination of the pixel. These leakage currents prevent the voltage applied to the pixel from being correctly maintained capacitively during writing, whereas this voltage should remain throughout the duration of a frame following the moment of writing.

Moreover, in an LCOS-technology display on a single-crystal silicon substrate, the pixels are very small, thereby making it difficult to provide each pixel with capacitors of sufficiently high capacitances.

### SUMMARY

This is why the invention provides a transmissive liquid-crystal display comprising a matrix of rows and columns of pixels, each pixel comprising a liquid crystal between a transparent pixel electrode and a transparent counter electrode common to all the pixels, a drive transistor and an auxiliary storage capacitor, the gate of the transistor being connected to a first row conductor common to all the pixels of a given row so as to receive from this conductor a write-control pulse, the drain of the transistor being connected to a column conductor common to all the pixels of a given column so as to receive therefrom an analog voltage representing a grayscale to be displayed, and the source of the transistor being connected to the electrode of the pixel and to a terminal of the auxiliary storage capacitor, which display is distinguished in that the transistor is located between the liquid crystal and the auxiliary storage capacitor, the capacitor consisting of a stack of at least two structures made of opaque metal having interdigitated parallel electrodes, each structure being produced in a respective metallization level, and each of the interdigitated-electrode structures comprising parallel fingers, the fingers of one structure being perpendicular to the fingers of the other structure.

The capacitor is then located on the upstream side (upstream in terms of the illumination) of the stack formed by the liquid crystal, the drive transistor and the auxiliary storage capacitor. In operation the light source of the display therefore illuminates the capacitor but does not or almost does not illuminate the transistor, the latter being masked by the capacitor. The rest of the pixel is not masked by the capacitor and light may reach the liquid crystal there where the capacitor is not an obstacle (i.e. through the transparent electrode).

The transistor and the auxiliary storage capacitor occupy a small part of the area of the pixel (smaller than 50% and as small as possible). Specifically, the lateral footprint of the capacitor must be minimized so that the aperture of the pixel, i.e. the ratio of the pixel area through which light may pass to the total pixel area, is kept as high as possible.

To obtain an auxiliary storage capacitor having the greatest possible capacitance and a lateral footprint the smallest possible, the capacitor consists of a stack of at least two interdigitated-electrode structures, each structure being produced in a respective opaque metallization level. The metallizations are preferably made of aluminum and/or copper. The interdigitated structures are separated by insulating layers and are connected to one another by conductive vias.

For example, in a display with six metallization levels, it is possible for four superposed levels to be used to produce four interdigitated-electrode structures each having two electrodes; the corresponding electrodes of the various levels are all connected to one another by vias. The directions of the fingers of two interdigitated structures on two different levels are alternated (perpendicular to each other) so as to better block the light.

In one embodiment, the capacitor comprises an electrode that occupies a continuous opaque area that covers the entire transistor.

A compensation capacitor may moreover be produced in the same stack of metal layers as the auxiliary storage capacitor. This capacitor is electrically connected between the pixel electrode and a conductive line that makes it possible to apply a compensation voltage. This capacitor contributes to the protection of the transistor from light and it may have an electrode that is continuous opaque and that covers the entire transistor.

The transistor and the auxiliary storage capacitor are preferably produced on the single-crystal surface layer of a silicon-on-insulator (SOI) substrate.

### BRIEF DESCRIPTION OF THE DRAWINGS

Other features and advantages of the invention will become clear on reading the following detailed description, given with reference to the appended drawings in which:

FIG. 1 shows the structure of a matrix liquid-crystal display;

FIG. 2 shows an equivalent circuit diagram with an auxiliary storage capacitor in each pixel, connected to the following row;

FIG. 3 shows another circuit diagram with an auxiliary storage capacitor, connected to an auxiliary conductive line, optionally with a compensation capacitor connected to a control conductor;

FIG. 4 shows an example of a conventional pixel structure for an amorphous-silicon active-matrix display;

FIG. 5 shows a diagram of a cross section through a transmissive pixel structure, according to the invention, in LCOS technology;

FIG. 6 shows schematically two capacitive interdigitated structures having fingers oriented in crossed directions, which structures may be used in the invention;

FIG. 7 shows a diagram of a cross section through another pixel structure, using three metallization levels; and

FIG. 8 shows a top view of an exemplary pattern for etching of the metallization for each of the three levels in FIG. 7.

### DETAILED DESCRIPTION

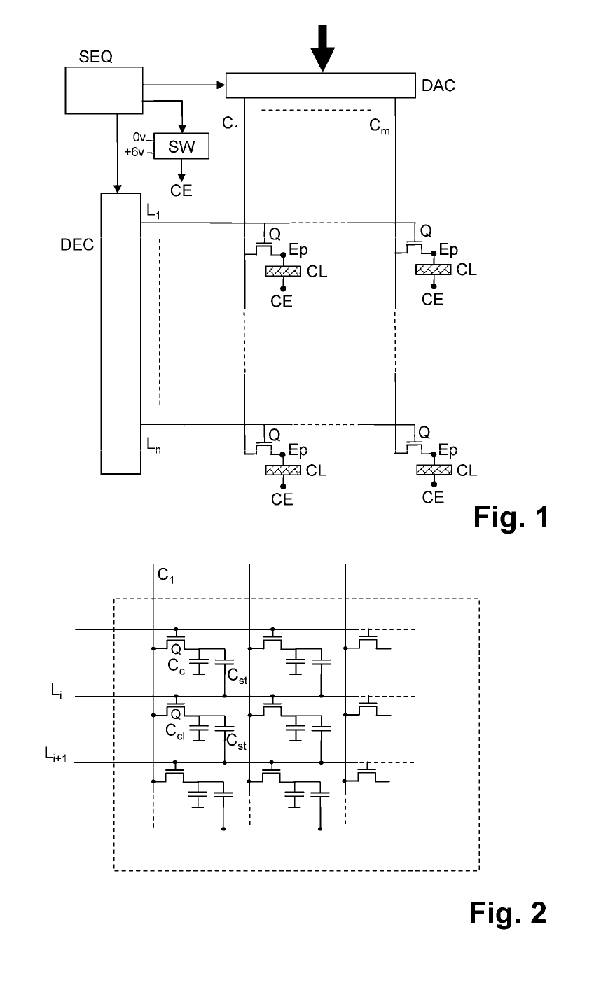

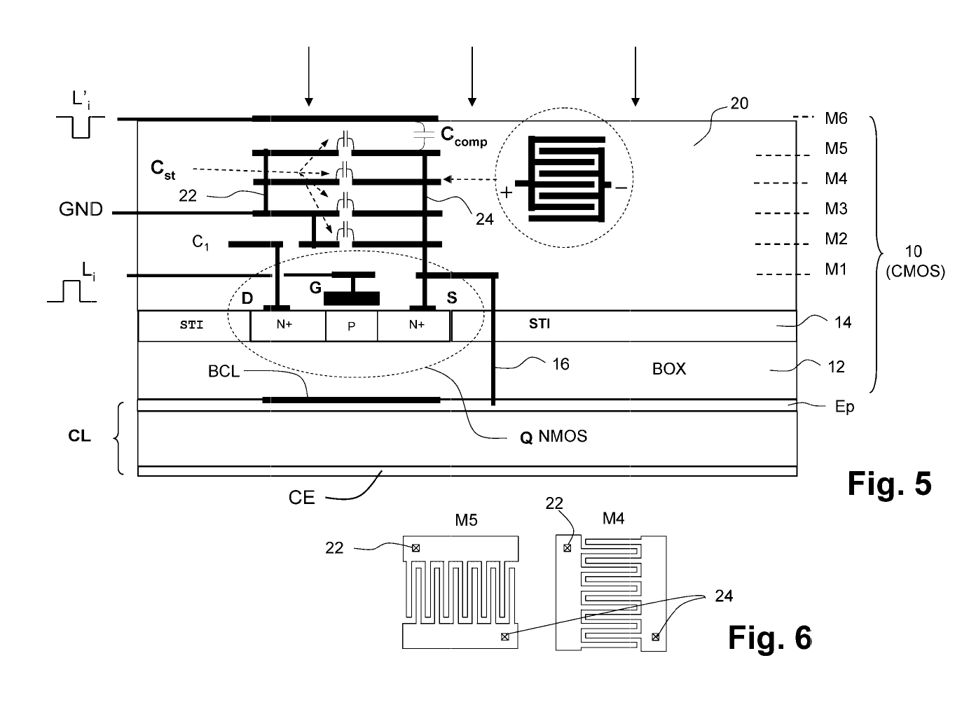

The transmissive liquid-crystal display comprises a matrix of rows and columns of pixels organized for example as in one of the diagrams shown in FIGS. 1 to 3. Only one pixel is shown in the cross section in FIG. 5. Each pixel comprises a liquid-crystal cell CL between a pixel electrode Ep and a counter electrode CE common to all the pixels. The drive transistor Q is made from a CMOS-technology structure 10, based on single-crystal silicon, bonded to the liquid-crystal cell. The common electrode CE and the pixel electrode Ep are transparent (made of ITO), but an opaque shield BCL (made of aluminum for example) is locally interposed between the pixel electrode and the transistor, so as to protect the transistor from light that could arrive via the liquid-crystal cell by way of reflection effects.

Various technologies exist for fabricating the CMOS structure 10. In the technology shown by way of example, the structure 10 is formed from an SOI (silicon-on-insulator) substrate. This substrate comprises, superposed, an insulating layer 12 of silicon oxide adjacent the pixel electrode Ep, and a layer of single-crystal silicon 14 in which the drive transistor is formed. The transistor shown is an nMOS transistor comprising an n⁺-doped source and an n⁺-doped drain that are separated by a p-type channel covered by an insulated gate G made of polycrystalline silicon. The transistor could alternatively be a pMOS transistor. The transistor is separated from the transistors of the adjacent pixels by silicon-oxide-filled STI (shallow trench isolation).

The transistor is covered by an alternation of insulating layers and metal layers making it possible to form the interconnects necessary to establish the circuit diagram for the matrix of pixels, and making it possible to form the auxiliary storage capacitor Cₛₜ and optionally the compensation capacitor C_{comp}. The metal layers are connected to one another and connected to the transistor by conductive vias that pass through the insulating layers. A conductive via 16 formed in the insulating layer 12 moreover makes it possible to establish a connection between the source of the transistor and the pixel electrode Ep.

The metal layers are preferably made of aluminum and/or copper. They are opaque to light and more particularly opaque to the light from a light source (not shown) of the display, placed above the stack shown.

The transistor occupies a small part of the area of the pixel (in the same way that a transistor is shown occupying a small part of the area of the pixel in amorphous-silicon technology in FIG. 4), and it is this part of the pixel that is mainly shown in FIG. 5.

In the example shown in FIG. 5 there are six superposed metallization levels, denoted respectively by the references M1 to M6. The number of levels could be different. The functions of the various levels could change and only an example thereof is given below, but in any case they are used to produce the storage capacitor Cₛₜ and optionally the compensation capacitor C_{comp}. They moreover form all the interconnects internal to the pixel and the interconnects (control lines, ground lines, column conductors, etc.) required for operation of the matrix. The metallization levels are shown symbolically by thick horizontal lines, and the vias are shown symbolically by thick vertical lines. The insulating layers (made of silicon oxide) that separate the levels are deposited in succession between the metallization levels deposited in succession, but they are shown as being a single insulating layer 20 in which the metallization levels are embedded.

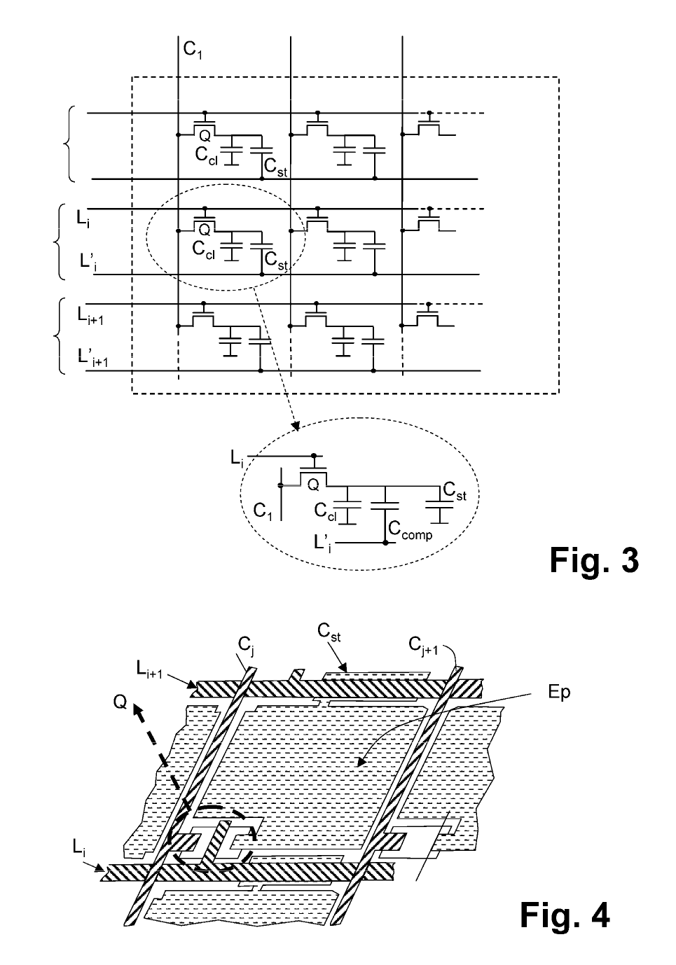

In the example in FIG. 5:
the level M1 has two functions: it forms the row conductor Lᵢ, connected by a via to the gate of the transistor, and simultaneously it connects the source of the transistor to the pixel electrode by way of the via 16; p1 the level M2 is used to produce the column conductor C₁ to which the pixel is connected, this being connected by a via to the drain of the transistor, and simultaneously it is used to produce part of the auxiliary storage capacitor Cₛₜ;
the level M3 is used for connection to a ground plane common to the entire matrix, and simultaneously it is used to produce another part of the auxiliary storage capacitor Cₛₜ;
the levels M4 and M5 are also used to produce part of the auxiliary storage capacitor Cₛₜ; and finally
the level M6 is used to produce, in this example, an electrode of the compensation capacitor C_{comp} if the compensation capacitor is different from the storage capacitor, or else part of the auxiliary storage capacitor Cₛₜ if there is no compensation capacitor; the level M6 is also used to form the compensation row conductor L′ᵢ if the circuit is arranged as shown in FIG. 3; the capacitor electrode produced in the last level M6 of the stack is preferably a continuous (opaque) metal area that covers all of the metal portions that are used to produce the storage capacitor Cₛₜ.

The arrangement of the conductors in the various metallization levels may be different from that indicated above: the level M1 rather than the level M3 could for example be used to form grounded interconnects, the level M3 could be used to connect L′ᵢ to the compensation capacitor and to form the compensation capacitor itself if there is one, etc.

The auxiliary storage capacitor Cₛₜ completely covers the transistor and prevents most of the light from penetrating as far as it. The greater the number of metallization levels above the transistor, the better the light barrier. The opaque shield BCL also protects the transistor from light liable to arrive from below.

To maximize the capacitance of the storage capacitor while limiting its lateral footprint, it is preferable for it to consist of a structure with interdigitated electrodes, and preferably it consists of the superposition of several structures with interdigitated electrodes, electrically connected in parallel.

Each of the levels M2 to M5, in the case shown by way of example, comprises a partial capacitor with interdigitated electrodes, i.e. the two electrodes of the partial capacitor are formed in the same metallization level. Each electrode comprises a series of conductors (or fingers of the structure) electrically connected to one another, located near conductors of another series of conductors belonging to the other electrode. The insulating layer 20 in which the metallization levels are embedded forms the dielectric between the fingers belonging to two electrodes. The drawing surrounded by a dashed circle is a plan view showing the principle and the general appearance of such a partial capacitor in the level M4. The other levels are similarly produced. The drawing shows the parallel fingers of the two electrodes, but in practice the precise layout of the electrodes depends on the space available in each level taking into account the interconnects required and notably the constraints related to the contact vias to be produced between the metallization levels.

Conductive vias such as 22 and 24 connect the corresponding electrodes between the various levels, so that the superposition of levels forms partial capacitors connected in parallel.

The fingers of the interdigitated electrodes are preferably oriented so as to be crossed from one level to another, so as to better prevent light from passing therethrough. FIG. 6 shows this crossed orientation, in a simplified configuration where the fingers are all parallel and rectilinear. In reality, the fingers of the electrodes of the capacitors may be more crooked.

It should be added that if the combs corresponding to two nonadjacent levels (such as M3 and M5 for example) have parallel fingers, it is possible to try to place the fingers of one level opposite the gaps between the fingers of the other level, again with the aim of reducing the penetration of light.

It will be understood that the capacitance of the capacitor formed by the interdigitated structures may be higher than the capacitance between two successive metal layers separated by an insulating layer. This is because the capacitance results from the fingers of the structures being opposed along their entire length. The fingers are elongate, there may be many of them and their width and their spacing may be a few microns.

Finally, the conductive vias between the various metallization levels help to protect the transistor from the light: they tend to trap any laterally propagating light. It is therefore advantageous to provide a plurality of vias, rather than just one, to connect two conducting elements that must be electrically connected.

In the example of FIG. 5, the compensation capacitor comprises a continuous opaque electrode, but it will be understood that it is alternatively possible for the storage capacitor Cₛₜ (or both capacitors) to possess a continuous opaque electrode.

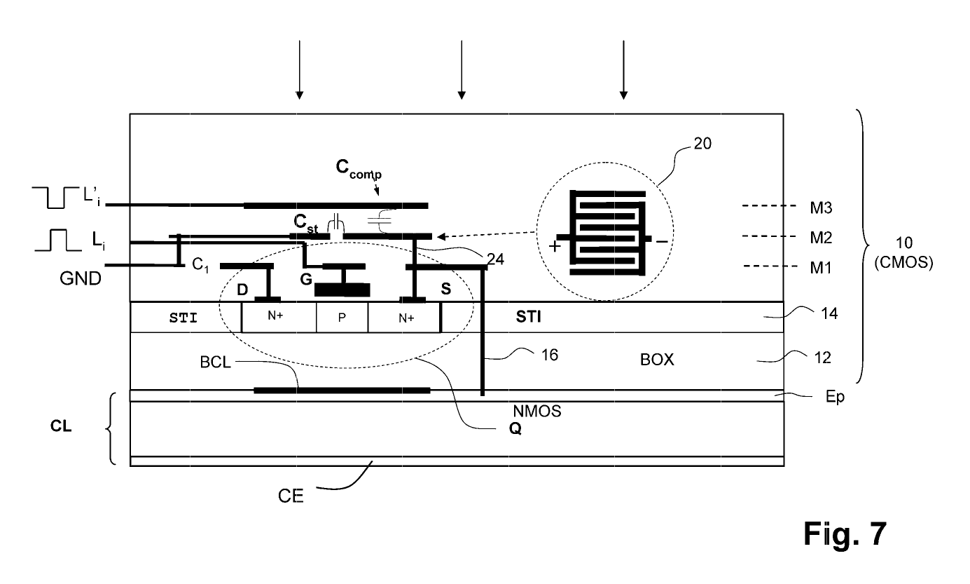

FIG. 7 shows another example of a pixel structure. In this example only three metallization levels M1, M2 and M3 are used. This is because it may be advantageous, for reasons of fabrication cost, to minimize the number of metallization levels. The effectiveness of the light protection is however reduced. In practice there will be at least three metallization levels. In the example in FIG. 7:
the level M1 is used to connect the source of the transistor to the pixel electrode by way of the via 16; it is also used to produce the column conductor C₁ to which the pixel is connected, connected by a via to the drain of the transistor; it is also used to produce a ground conductor GND; and finally it may be used to form an interdigitated capacitor that makes up part of the storage capacitor Cₛₜ;
the level M2 is used to produce the row conductor Lᵢ and another (interdigitated) part of the storage capacitor Cₛₜ, connected in parallel with the capacitor part formed in the metallization level M1; and finally
the level M3 is used to produce, in this example, an electrode of the compensation capacitor C_{comp} if the compensation capacitor is different from the storage capacitor, or else part of the auxiliary storage capacitor Cₛₜ if there is no compensation capacitor; the level M3 is also used to form the compensation row conductor L′ᵢ if the circuit is arranged as shown in FIG. 3; the capacitor electrode produced in the last level M3 of the stack is preferably a continuous (opaque) metal area that covers all of the metal portions that are used to produce the storage capacitor Cₛₜ; the other electrode of the capacitor C_{comp} is formed by one of the electrodes of the interdigitated storage capacitor of the level M2.

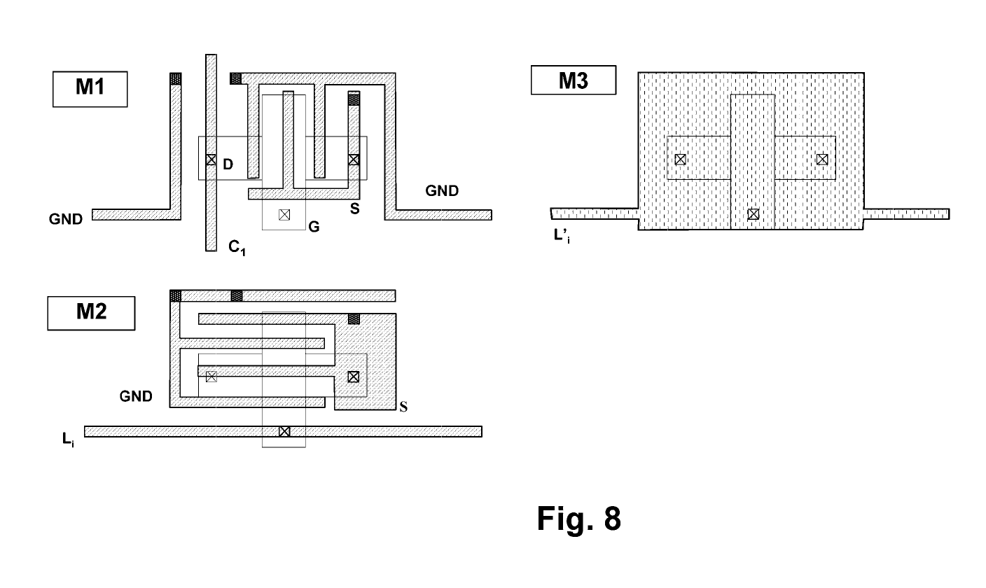

FIG. 8 shows a possible configuration for the three metallization levels M1, M2 and M3, for forming the elements indicated above. The figure shows the connection vias between the levels (as darker, hashed regions), and vias connecting to the source, gate and drain of the transistor.

The auxiliary storage capacitor Cₛₜ covers the transistor and prevents most of the light from penetrating as far as it. The greater the number of metallization levels above the transistor, the better the barrier against the light.

In the configuration in FIG. 8, it is the compensation capacitor C_{comp} that possesses a continuous, opaque electrode completely covering the transistor so as to better protect it from light. The transistor is therefore very well protected by the assembly comprising the storage capacitor and the compensation capacitor from illumination by the light source of the transmissive display.

I claim:

1. A transmissive liquid-crystal display comprising:
a matrix of rows and columns of pixels, each pixel comprising
a liquid crystal between a transparent pixel electrode and a transparent counter electrode common to all the pixels,
a drive transistor, and
an auxiliary storage capacitor, wherein
a gate of the transistor is connected to a first row conductor common to all the pixels of a given row so as to receive from the first row conductor a write control pulse,
a drain of the transistor is connected to a column conductor common to all the pixels of a given column so as to receive therefrom an analog voltage representing a grayscale to be displayed,
a source of the transistor is connected to the pixel electrode and to a terminal of the auxiliary storage capacitor,
the transistor is located between the liquid crystal and the auxiliary storage capacitor, and
the auxiliary storage capacitor comprises a stack of at least first and second structures made of opaque metal and having interdigitated parallel electrodes, each structure being produced in a respective metallization level, and each of the interdigitated-electrode structures comprising parallel fingers, with the fingers of the first structure being perpendicular to the fingers of the second structure.

2. The display according to claim 1, wherein the transistor and the auxiliary storage capacitor occupy an area smaller than 50% of the area of the pixel.

3. The display according to claim 2, wherein the capacitor comprises a stack of at least three metallization levels separated by insulating layers, with conductive vias connecting the various levels depending on the interconnections to be made.

4. The display according to claim 1, wherein the capacitor comprises an electrode that forms a continuous opaque area that covers the entire transistor.

5. The display according to claim 1, further comprising a compensation capacitor connected to an auxiliary row conductor connecting all the pixels in a given row, the compensation capacitor being located above the transistor.

6. The display according to claim 2, further comprising a compensation capacitor connected to an auxiliary row conductor connecting all the pixels in a given row, the compensation capacitor being located above the transistor.

7. The display according to claim 3, further comprising a compensation capacitor connected to an auxiliary row conductor connecting all the pixels in a given row, the compensation capacitor being located above the transistor.

8. The display according to claim 5, wherein the compensation capacitor comprises an electrode having a continuous opaque area that covers the entire transistor.

9. The display according to claim 6, wherein the compensation capacitor comprises an electrode having a continuous opaque area that covers the entire transistor.

10. The display according to claim 7, wherein the compensation capacitor comprises an electrode having a continuous opaque area that covers the entire transistor.

11. The display according to claim 1, produced using LCOS technology, the transistor and the auxiliary storage capacitor being produced on a single-crystal surface layer of a single-crystal-silicon-on-insulator (SOI) substrate.

12. The display according to claim 2, produced using LCOS technology, the transistor and the auxiliary storage capacitor being produced on a single-crystal surface layer of a single-crystal-silicon-on-insulator (SOI) substrate.

13. The display according to claim 3, produced using LCOS technology, the transistor and the auxiliary storage capacitor being produced on a single-crystal surface layer of a single-crystal-silicon-on-insulator (SOI) substrate.

14. The display according to claim 4, produced using LCOS technology, the transistor and the auxiliary storage capacitor being produced on a single-crystal surface layer of a single-crystal-silicon-on-insulator (SOI) substrate.

15. The display according to claim 5, produced using LCOS technology, the transistor and the auxiliary storage capacitor being produced on a single-crystal surface layer of a single-crystal-silicon-on-insulator (SOI) substrate.
